(19) United States
(12) Patent Application Publication
(10) Pub. No.: US 2003/0033438 A1
(43) Pub. Date: Feb. 13, 2003

(54) Method for automatically allocating a network planning process to at least one computer

(76) Inventors: Ulrich Gremmelmaier, Germering (DE); Peter Jocher, Pfaffenhofen (DE)

Correspondence Address: MORRISON & FOERSTER LLP, 1650 TYSONS BLVD. - SUITE 300, MCLEAN, VA, 22102, US

(21) Appl. No.: 10/239,303

(22) PCT Filed: Mar. 2, 2001
(86) PCT No.: PCT/DE01/00794

(51) Int. Cl. G06F 9/00

(52) U.S. Cl. 709/310

(57) ABSTRACT

Method for automatically assigning a network planning process to at least one computer The invention relates to a method that automatically assigns a complex process (10), preferably the emulation of a PNNI-based ATM network, to a plurality of computers (46) with different performance characteristics and characteristic values, the method taking dynamic changes in the network into consideration. In this connection, the method comprises the following steps: a) determination of specific assessment parameters (54) of the computers, b) determination of sub-processes, c) structuring of the sub-processes, d) assignment of the sub-processes to the computer(s) (46), and e) optionally, output of assignment data.

The invention relates to a method for assigning a process to at least one entity, particularly to a computer, with an inter-process communication, particularly a method for assigning a network planning process to available computers of any configuration.

In the case of procedures that run with computer support, it is very frequently necessary to break the procedure, the main process, in each instance, down into individual sub-procedures or sub-processes, in order to be able to distribute these sub-processes among several available computers. This becomes clear if one considers the (limited) resources of the computers in question, and the tasks, which are very extensive and complicated, in some cases. Frequently, one is dependent on the fact that a procedure must be carried out within the shortest possible period of time. If one furthermore considers that three computers might be available for this task, but that the first is currently overloaded with a long-term application, the second has too little memory to be able to perform this task as a whole, and the third has sufficient memory and a free CPU—but has an Ethernet connection to the LAN that is too small in size for the entire task—then it is necessary to divide the task into sub-tasks and to determine the respective computer parameters, and then to assign the sub-tasks to the computers with the required capabilities, so that the task can be optimally divided and efficiently carried out. The main area of application of the method, according to the invention, therefore lies particularly in those areas that include dynamic conditions—in other words, conditions that change over time—so that such an assignment process becomes necessary at every point in time.

Such a method of procedure is necessary in planning large networks, for example. Here, the method of procedure must be as optimal as possible in terms of time and resources, in order to make the network fast and reliable, and to fulfill the required quality standards. In this connection, the topology is established, among other things, and the network nodes and links or network connections, including the virtual connections, are set. For this purpose, a so-called traffic matrix is used, and established quality standards are observed.

Since the system conditions of the network also change due to the constantly changing requirements, so that existing nodes are dissolved, new ones are added, or links are changed, the known static tools, which, for example, cannot take changes in the topology of the network or a changed traffic guidance pattern into account, are no longer sufficient.

It is necessary that in the case of a complex task, such as a tool for network planning, dynamic processes also be taken into consideration, and that the available computers be assessed and evaluated with regard to their performance spectrum for taking on specific sub-tasks, so that an optimal and automatic distribution of tasks can thereupon take place.

Up to the present, numerous network providers in this field have offered network planning tools, but these are not based on a distributed task, in this case, a distributed emulation, and presume that the task will run on a central computer, which will then, of course, frequently be overloaded, so that the entire planning task cannot be carried out satisfactorily.

Review and monitoring of the network planning is necessary, for example, in the case of so-called ATM networks (Asynchronous Transfer Mode), which are based on the PNNI standard (Private Network Node Interface). The PNNI protocol is suitable for private networks of any size, because of its scalable traffic guidance process. Since this technology is based on quasi self-organizing running of the network, which is characterized by a high degree of dynamics, a (review of the) network planning is necessary, and an assignment of planning sub-tasks, according to the invention, to available computers is necessary.

ATM, very generally, relates to a transmission process that is based on an asynchronous time multiplexing process. ATM technology makes a technology available that is able to fulfill current requirements, specifically in telecommunications technology, such as the highest possible guaranteed bandwidth, and the possibility of processing several services. ATM technology opens up the possibility of processing several virtual transmission channels. On these channels, their capacity can be freely adapted to the respective application. In this connection, data with a fixed length are transported. These data packets are called cells and have a size of 53 bytes. The network comprises several switching centers, which are called switches, and by way of which the respective data are passed on. As needed, the ATM switches disconnect a virtual connection from a source (sender of the data) to a destination (receiver of the data). In an ATM network, different services can be transmitted, which deliver a data stream with a constant bit rate (CBR) or with a variable bit rate (VBR), for example (the transmission of voice, for example, requires a constant bit rate, and the transmission of video requires a variable bit rate).

All of the data are brought into a pre-defined form in these networks, and stored in a so-called ATM cell (with an established header, etc.). Using the ATM technology and the PNNI protocol, large networks with a flexible and scalable routing architecture can be established.

The PNNI protocol comprises a signal and routing protocol that was designed in such a way that it can be used for a network with worldwide scope.

PNNI routing uses source routing to determine the path through a network. For this reason, every node needs a description of the topology of the network, in order to be able to carry out the necessary calculations and activation procedures. For this reason, distribution of this data must be guaranteed by the routing protocol. Between the nodes, a continuous exchange of network data assures independent recognition of the network topology. The PNNI protocol provides a three-stage data structure for topology information (IG—Information Group; PTSEs-PNNI Topology State Elements; PTSP-PNNI Topology State Packet).

The information is distributed by means of flooding. The PNNI routing protocol is based on dynamic routing and is designed for several hierarchy levels, and supports pre-determined quality standards. Therefore, the PNNI protocol is far more complex than others. Solely for this reason, the design and planning aspect for ATM networks on which the PNNI protocol runs is important. Furthermore, the ATM switches represent a limitation for the system, in that they must be able to process the data amounts for a respective terminal in order to be able to serve this terminal with the proper transmission speed. This aspect also brings with it the need to plan such a network precisely and, in particular, to investigate dynamically, and as error-free as possible, what data amounts can be processed by the various ATM switches, for example. Such a network planning tool has been published as a so-called PNNI emulator (see U. Gremmelmaier, M. Winter, P. Jocher: “The PNNI Emulator: A Versatile Tool for Planning an Operation Support of PNNI Networks.” International Telecommunication Network Planning Symposium, Sorrent, October (1998).

For this purpose, a breakdown of this complex task is necessary, so that it can be carried out as a bundle of distributed sub-tasks on available, suitable computers and/or platforms.

Therefore, the task of the present invention is to provide a method in which a complex, time-intensive and CPU-intensive task can be carried out, optimized in terms of time and performance, error-free, with limited computer resources.

This task is accomplished, according to the invention, by means of the method stated initially, particularly by means of a method for assigning a network planning process, which includes the following steps:

a) Determination of specific assessment parameters for assessment of the available performance and capacity utilization of the entities involved in the process,

b) Determination of sub-processes,

c) Structuring of the sub-processes with regard to their priority and their scope,

d) Manual and/or automatic assignment of the sub-processes to the entity/entities, based on the determination of the assessment parameters and the determination and/or structuring of the sub-processes.

As explained above, such tasks and processes lie not just in the sector of emulation or, in general, the planning of networks. In very many fields, it is necessary to break down complex and computer-intensive processes on the basis of limited resources, in such a way as to ensure optimal operation. Chip design, for example, involves the task of checking, monitoring, and emulating the functionality of the chip to be designed. For this purpose, a complex process (the so-called network list) also has to be assigned to individual, limited components of a (hardware) emulator, such as specific processors or FPGAs (Field Programmable Arrays). The method according to the invention can be used also for this purpose, in that the process is distributed to the available entity, in this case several components of an emulator. In the database sector, it also frequently necessary to carry out extensive tasks on individual workstations with limited capacity, in order to be able, if necessary, to determine key variables, which in turn provide information about the current behavior of the process and, based on this information, to be able to optimize the planning and design of the process.

But particularly in the case of large networks, particularly those that are based on PNNI, the increased complexity due to the traffic guidance process requires monitoring devices and methods, in order to permit conclusions and statements concerning the active network operation, as well as methods for improving performance. The creation of a platform for such a monitoring method that takes the dynamic changes of the network over time into consideration, and that can be carried out with normally designed computer capacity—in other words, without a high-performance system—is another task of the present invention.

In a preferred embodiment of the invention, the method is designed as a method for dividing an extensive network-planning task up among a freely selectable number of computers configured in any way. As described above, in quasi self-organizing networks the need exists to monitor the network and topology planning, and to optimize it, as necessary. However, only a few, normally configured computers with a standard performance profile are available for this complex task. The need exists to break the main task down into various sub-tasks, in such a way that these sub-tasks can be divided up among the computers and carried out there. Furthermore, in this connection the task was further to create a possibility that the complex planning task can be broken down and assigned in such a way that during an emulation of the network, not only virtual nodes but also real nodes can be included in the emulation.

For this purpose, the method according to the invention is preferably designed as a hybrid method, so that it allows the inclusion of real nodes and/or virtual nodes in the emulation process. The result achieved is that the mechanism of self-organization in PNNI networks can be studied under real-time conditions, and clear measurement variables can be measured. Measurement variables can be, among others: the speed of data transmission to other nodes, if a node fails or if modifications of transmission points occur; transmission of information about other topology changes, with the establishment of a proportional multiplier that indicates the extent of data transmission to other nodes; call blocking data; stability statements; node capacity utilization and other parameters that are necessary for setting timer values and threshold values.

Another particularly preferred embodiment contains a graphical interface that can optionally be activated during the emulation process, but which is not a required prerequisite for the process to run, since it would possibly use up computer performance that might become important, which would then be unavailable to the emulation process. Of course, control can also be carried out on a separate computer, as an alternative. An embodiment of the present invention that has proven to be very advantageous in practical situations relates to the assignment of a network-planning task in a PNNI network.

PNNI networks are organized in a hierarchy, so that the physical layer is imaged in a structure that lies higher in the hierarchy, in which structure the nodes are brought together in groups and in which a data exchange, which is now a virtual data exchange, takes place. In order to also be able to emulate this group formation during the emulation process, a very advantageous embodiment of the present invention includes the possibility of being able to run the emulation in just as divided a manner, in that several hosts that house PNNI nodes can be linked into the process. This results in the advantage that the complete process load that occurs does not have to be carried by a single computer, as before, where this computer was very frequently overloaded, according to the state of the art.

Additional advantages of the invention and particular embodiments with their characteristics are shown in the following detailed figure description.

The figures show:

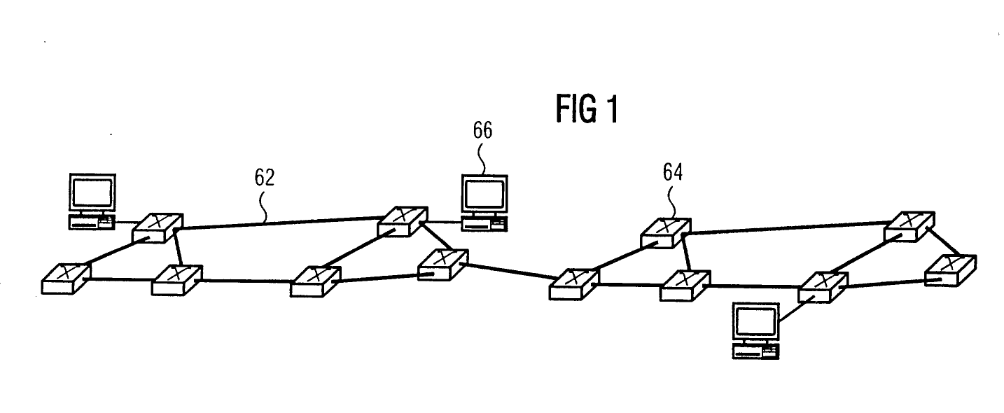

FIG. 1 a representation of the lowest hierarchy level of a network based on PNNI,

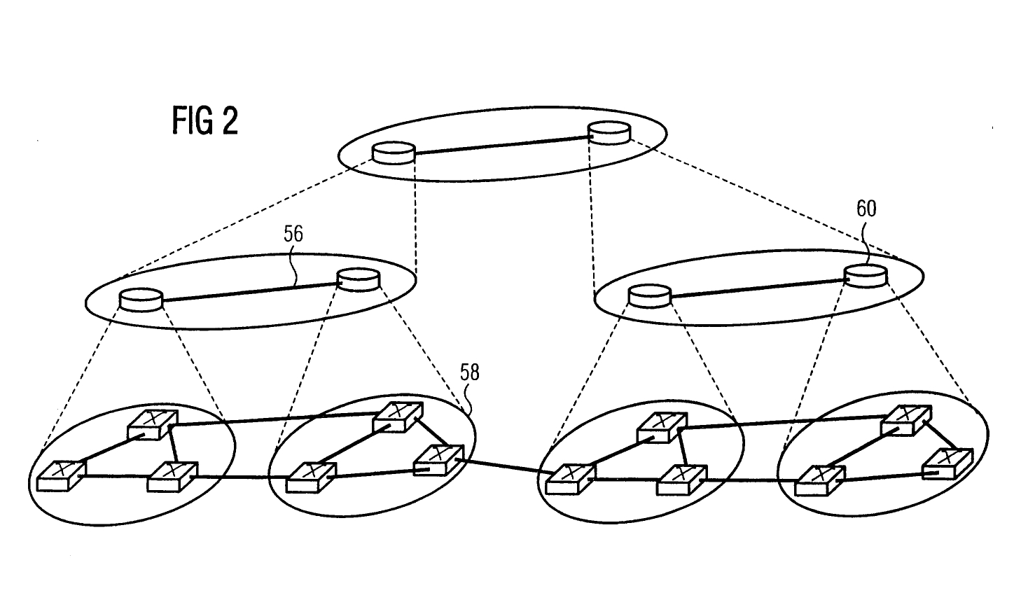

FIG. 2 a representation of three hierarchy levels of the basic structure of a network from FIG. 1,

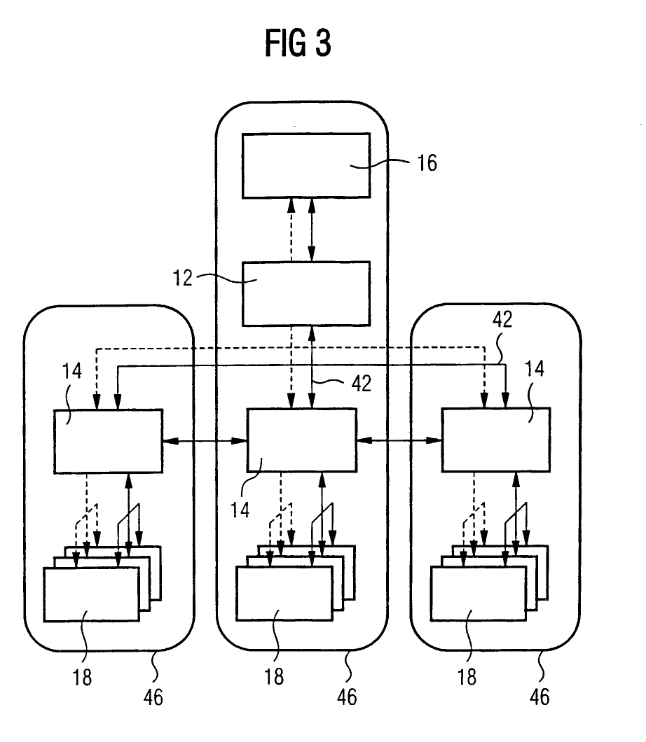

FIG. 3 an overview representation of essential sub-processes of a network planning task,

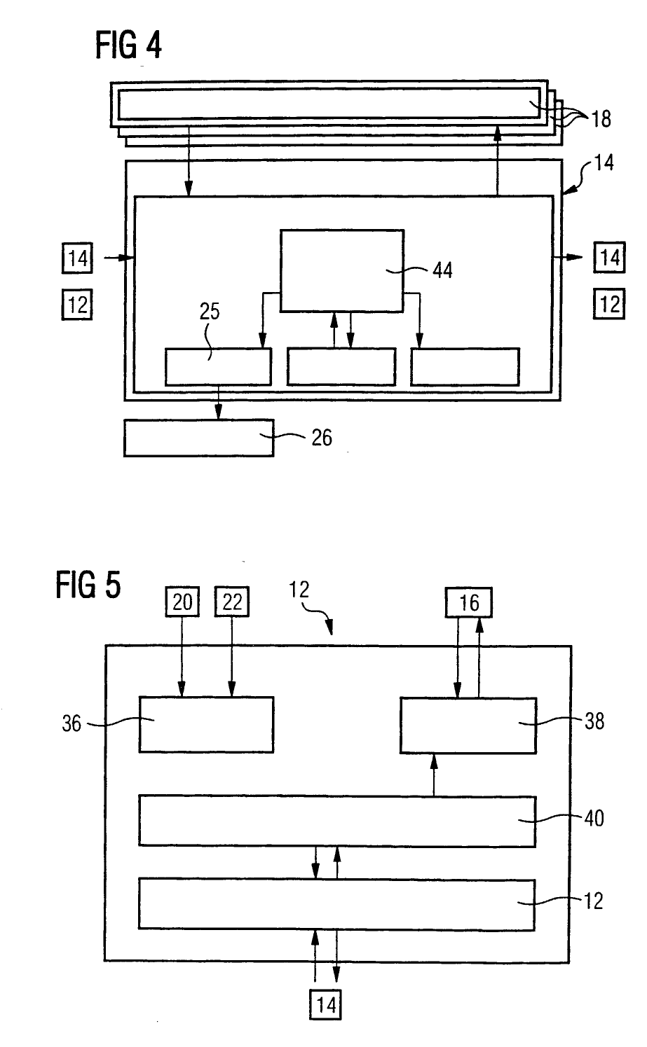

FIG. 4 an overview representation of a message distributor in an advantageous embodiment of the present invention,

FIG. 5 an overview representation of the architecture of a message control in the advantageous embodiment according to FIG. 4, and its inclusion in the main process,

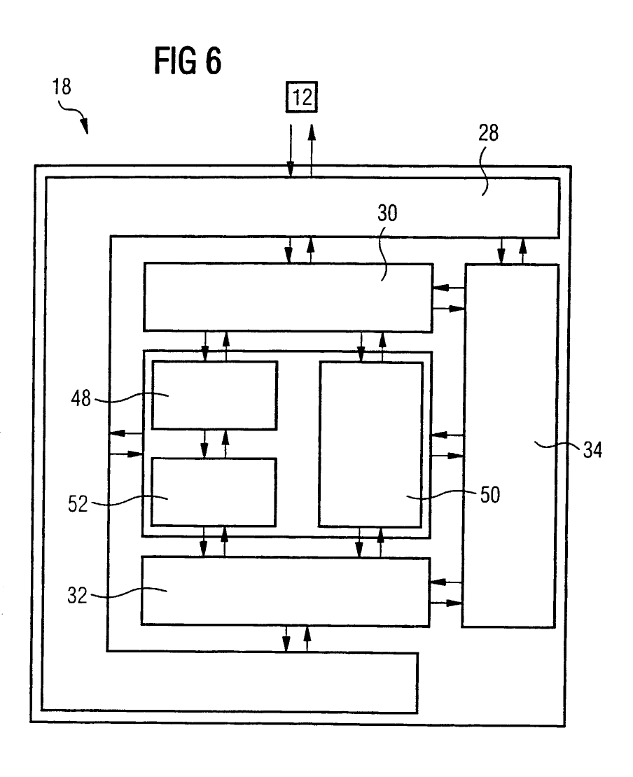

FIG. 6 an overview representation of a node process in the advantageous embodiment according to FIG. 4,

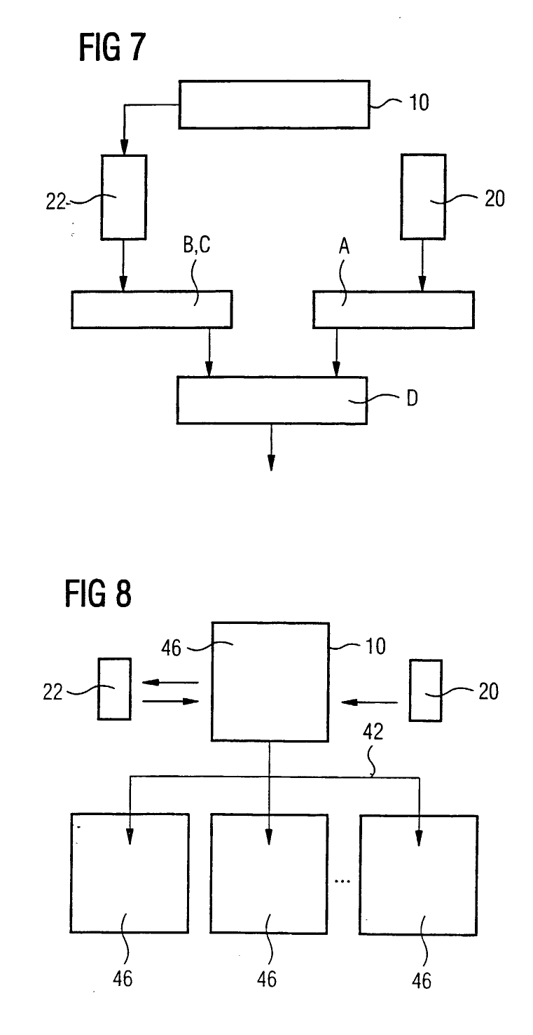

FIG. 7 a flow chart of the method according to the invention, and

FIG. 8 a block schematic of the method according to the invention.

In the following, the general sequence of the method according to the invention will be briefly presented as an introduction.

It relates to a complex process, with several computers available to implement it, which computers can differ in terms of their key variables, such as the size of the main memory and the like, and which do not have to be special high-performance computers. In an important embodiment, the following assessment parameters 54 are determined: operating system (type and version), main memory (size and current capacity utilization), swap region (size and current capacity utilization), LAN access (maximum and current throughput), and LAN segments (average running time among the individual computers, maximum and current throughput), current CPU capacity utilization, and the long-term capacity utilization of the aforementioned parameters. These assessment parameters 54 are weighted with regard to taking over the respective sub-processes, in order to increase the efficiency of the assignment method. Using the method according to the invention, the advantage results that in the case of a CPU-intensive, complex task, uniform utilization of limited resources is achieved and information technology “bottlenecks” are avoided. Furthermore, the communications and coordination effort among the individual computers is significantly reduced.

As shown in FIG. 7, the complex process 10 serves as the input for a planning file 22, the content of this file serving to determine the sub-processes b and their structuring c. If possible, the sub-processes are advantageously uncoupled from the respective other sub-processes. Data relevant for the process 10, particularly data concerning the performance capacity of the available computers 46, are stored in a configuration file 20. In step A, this performance capacity is analyzed and evaluated. In steps B and C, the data of the planning file 22 are processed, so that a capacity-oriented breakdown of the main process into various sub-processes takes place. After steps A, B, and C, in step D, the sub-processes are assigned to the computers on the basis of the data developed in steps A, B, and C. Afterwards, the complete process 10, which has thus been optimally divided among the computers, can run.

FIG. 8 shows the distribution or general assignment of the sub-processes of the total process 10 among the individual computers in greater detail; the computers are in data exchange with one another by way of an inter-process communication 42.

In FIG. 3, the main process, designated in general as 10, relates to an emulation process of a network, which is essentially broken down into the following sub-processes: an emulation control 12, a message distributor 14, a graphical user interface 16, and node processes 18.

The network here is a PNNI network whose fundamental structure is shown in FIG. 1, and whose group formation (into single and multi peer groups) is shown in FIG. 2. FIG. 1 shows the physical networking with physical links 62 that are in data exchange with one another by way of switches 64. The terminal computers 66 can communicate with one another in this way. FIG. 2 shows the different hierarchy levels (3 here) of an ATM network that is based on PNNI routing, with the lowest physical level shown in FIG. 1, and with the virtual levels that include the logical group nodes 60 of a represented peer group 58 and the virtual links 56.

The performance capacity of each computer 46, and of the network environment being used, is determined using a measurement procedure according to the invention (in step a)), and reported to the central control 12.

The control 12 controls the distribution of the node processes 18 to the computers/hosts 46 that are involved, by way of the message distributor 14.

The control 12 of the emulation is located centrally on a computer. During the emulation 10, it transmits a planning file 22 to individual nodes 24. The configuration file 20 comprises the data essential for the emulation 10, in the form of a script language. It contains topology and configuration data, connection pulse patterns and error scenarios, such as node and/or link failures, which are stored in the file 22 with a time stamp, and are then passed to the message distributor 14 under time control and selectively. Here, selectively means that the control 12 only passes on those messages to the message distributor 14 that are relevant for it to economize on computing performance. Furthermore, the file 22 contains the control of logging and trace information that occurs during the emulation 10.

The control 12 is responsible for coordination of the entire emulation 10. Furthermore, it initiates the node processes 18, it carries out their configuration, and serves for error emulation.

The message distributor 14 is represented once on every computer that is involved in the emulation. All of the message distributors 14 are linked into an inter-process communication by way of TCP connections. The socket interfaces 38, in combination with the message distributor 14, emulate both the physical links and the ATM links. Furthermore, the message distributors 14 for each computer comprise a central call generator and a process that stores the message stream for a subsequent analysis of the measurement data obtained.

The instantiation of the node processes 18 is carried out by the message distributor 14 upon request by the control 12,. During the measurement run, the message distributors 14 transmit the messages to the local node processes 18 or to other workstations.

In a particularly preferred embodiment of the invention, the emulation process is additionally equipped with the graphic interface 16, which can optionally be used during an emulation run. It serves to input network topologies and to visualize and interactively influence an ongoing measurement. It is connected with the central control 12.

Preferably, the method of distributed emulation according to the invention can be used for PNNI networks because, according to their protocol, these already provide for grouping and structuring (in the sense of a hierarchy formation). Preferably, the assignment is therefore chosen in such a way that it takes into consideration the peer groupings of the individual nodes in a distribution step d, in order to be able to take the group formation or connectivity of individual nodes into consideration. As an alternative, explicitly existing network clusters can also be brought together for a sub-process. In this case, the individual sub-processes are advantageously assigned to the individual computers in accordance with their weight, which results from the number of nodes and links they contain, and taking into consideration the assessment parameters 54 of the computers. If, however, there are fewer computers available than there are sub-processes, one computer can also have several sub-processes assigned to it. In an extreme case, the entire planning task or, in general, the entire main process, can be imaged on only a single computer. When several sub-processes are brought together and assigned to a single computer, it is taken into consideration, according to the invention, that preferably those sub-processes that have a stronger than average link with one another have priority in being assigned together (or distributed to a computer together). In another extreme case, namely one in which even a sub-process has to be divided up among several computers, the solution according to the invention provides that the greater consideration is given to the performance capacity of the network connections among the computers involved, such as a high-performance and fast LAN connection.

FIG. 5 shows the central control 12 of the process 10. Its interfaces consist of interfaces to the planning file 12, to the graphical interface 16, and to the message distributor 14. A script interpreter 40 converts the data received by way of the interfaces, particularly the data received by way of the file interface 36, into a form that is comprehensible for the processes. Status reports of the emulation process 10 are transformed into the script language and passed on to socket interfaces 38.

FIG. 4 shows the message distribution process 14. During a measurement run, the message distributors 14 transmit the messages to the local node processes 18. If there is a large stream of messages, a built-in message buffer 44 stores the data in the sequence in which they arrive until they can be processed.

During the entire emulation, logging 25 takes place. It ensures that the acquired message stream is stored in a file, a log file 26. Thus, for example, the type and content of the message, its time, its size, and the addresses of the source and the destination are noted, in order to allow statistical evaluation after the emulation. A configurable filter makes it possible to filter out those data that are not relevant to the analysis.

Other data measured by the process 10, which are stored in the log file 26, relate to indirectly contained grouping data of nodes within the network, the current and long-term network capacity utilization, blocking information (place and time of call blocking). During the emulation of a PNNI network, the effects of a so-called proportional multiplier can also be determined; it delivers the option of a message threshold to enable adjustments to be made when changes are to be viewed as significant. Such changes are on a link, in the available capacity. This makes it possible to control the frequency of the topology exchange and the accuracy of the databases.

In this case, the node processes 18 contain the PNNI protocol. The related software is specifically designed for the method according to the invention, in order to be able to assure that it can be tied in with the emulation environment.

As can be seen in FIG. 6, adaptation to the operating system and to the interfaces, for the purpose of emulation, takes place by means of the system services module 28, which surrounds the node software like a shell. The module 28 communicates, towards the outside, with the control 12, and, within the node 18, with a call control module 30, an AAL adapter 32, and a layer manager 34. The layer manager 34 serves to control and monitor the PNNI signaling 48, the Q.SAAL layer 52, and the PNNI routing 50. The AAL adapter 32 images the transport of ATM messages between the nodes on the communications model of the emulation. The call control module 30 converts the connection pulses of the local message distributor 14 into call requests and routing requests to the protocol software, and disconnects the calls again at a later time.

The planning file 22 shown in FIG. 7 and 8 preferably contains data for the basic configuration of a respective node, such as the number of ports, the number of possible links, data relating to the respective links and nodes, such as bandwidth, traffic pattern, and, optionally, other general parameters, such as the number of database access procedures to be carried out, the scope of the selective logging, and the like.

1. Method for assigning a process (10) to at least one entity, with an inter-process communication (42), particularly a method for assigning a network planning process, comprising the following steps:
a) Determination of specific assessment parameters (54) for assessment of the available performance and capacity utilization of the entities involved in the process,
b) Determination of sub-processes,
c) Structuring of the sub-processes with regard to their priority and their scope,
d) Manual and/or automatic assignment of the sub-processes to the entity/entities, based on the determination of the assessment parameters (54) and the determination and/or structuring of the sub-processes.

2. The method as recited in claim 1, characterized in that the entity is a computer (46).

3. The method as recited in one of the preceding claims, characterized in that it additionally contains the following characteristic e): output of process and assignment data by way of a graphical interface (16).

4. The method as recited in one of the preceding claims, characterized in that the assessment parameters (54) at least contain information about: operating system, processor, main memory, swap region, network connection, interfaces.

5. The method as recited in one of the preceding claims, characterized in that the process (10) is a network-planning task for measuring network parameters in networks with dynamic routing.

6. The method as recited in one of claims 1 to 5, characterized in that the process (10) relates to emulation of the network.

7. The method as recited in one of claims 5 or 6, characterized in that the networks to be emulated are ATM networks that are based on the PNNI standard.

8. The method as recited in one of claims 5 or 6, characterized in that the networks are IP networks.

9. The method as recited in one of claims 6 or 7, characterized in that the sub-processes comprise a central control (12), at least one message distributor (14), and at least one node process (18).

10. The method as recited in one of claims 5 to 9, characterized in that during the process (10), particularly while an emulation is running, changes in the network to be emulated can take place, particularly changes in nodes and/or links.

11. The method as recited in one of claims 5 to 10, characterized in that during the process (10), particularly while an emulation is running, at least one real node is linked in, which can subsequently be switched on and off.

12. The method as recited in one of the preceding claims, characterized in that network parameters are measured that include at least the following parameters:
call blocking rates, parameters concerning call creation (number and duration), data occurrence within a partial region of the network and/or within the entire network, data processing effort within individual nodes.
